(19) United States
(12) Patent Application Publication
(10) Pub. No.: US 2014/0303267 A1
(43) Pub. Date: Oct. 9, 2014

(54) PROCESS OF RECYCLING PAINT SLUDGE, POWDER COAT MATERIAL AND/OR LATEX PAINT AND A COMPONENT MADE THEREOF

(71) Applicant: Preferred Filter Recycling, St. Clair Shores, MI (US)

(72) Inventors: Dan Chrzanowski, Lexington, MI (US); Brandon Chrzanowski, St. Clair Shores, MI (US)

(73) Assignee: Preferred Filter Recycling, St. Clair Shores, MI (US)

(21) Appl. No.: 14/246,612

(22) Filed: Apr. 7, 2014

Related U.S. Application Data
(60) Provisional application No. 61/808,834, filed on Apr. 5, 2013.

(51) Int. Cl. C08J 11/04

(52) U.S. Cl. CPC C08J 11/04; C08J 2467/00; C08J 2475/04; C08J 2363/00; C08J 2333/08
USPC 521/40.5; 521/40; 521/48; 521/49

(57) ABSTRACT

A process for making a solid component out of recycled paint sludge, powder coat and/or latex paint is provided. The process can include providing paint sludge, powder coat and/or latex paint and providing a second material. Thereafter, the paint sludge, powder coat and/or latex paint and the second material are mixed to produce a paint sludge, powder coat and/or latex paint-second material mixture. The paint sludge, powder coat and/or latex paint-second material mixture is processed in order to produce a solid component. The processing can include extrusion of the paint sludge, powder coat and/or latex paint-second material mixture.

### RELATED APPLICATION

The instant application claims priority to U.S. Provisional Patent Application Ser. No. 61/808,834, filed on Apr. 5, 2013, which is incorporated in its entirety herein by reference.

### FIELD OF THE INVENTION

The present invention is related to a process for recycling, paint sludge, powder coat material, latex paint and the like. In particular, the present invention is related to a process for recycling paint sludge, powder coat material, latex paint and the like in which a solid component can be made therefrom.

### BACKGROUND OF THE INVENTION

Paint is a commonly manufactured and used substance with millions of tons produced and used every year. As such, paint waste, often referred to and/or in the form of paint sludge and/or powder coat waste, exceeds thousands of tons every year and can create a variety of environmental and economic problems. In addition, increasingly stringent governmental pollution regulations as well as the cost of waste disposal have led to increased concerns regarding the treatment and disposal of paint sludge.

Paint sludge can include a variety of uncured polymer resins, pigments, curing agents, surfactants and other minor formulation ingredients. In addition, the paint sludge can contain water and/or a variety of organic solvents.

Powder coating, often referred to as “powder coat”, is a type of coating process that is typically applied using a free-flowing, dry powder. The process does not require a solvent to keep a binder and filler parts in a liquid suspension form as with paint and the dry powder is usually applied electrostatically and then cured under heat to allow it to flow and form a coating layer. The dry powder can be a thermoplastic or a thermoset polymer and is the process is used for coating metals, such as “whiteware”, aluminum extrusions, automobile parts, bicycle parts and the like. However, the process can result in waste powder particles that do not get applied to a substrate and up to 5% of the dry powder as originally produced is not suited for the coating application. Therefore, a process for recycling the powder coat and/or a component made out of recycled powder coat would be desirable.

### SUMMARY OF THE INVENTION

A process for making a solid component out of recycled paint sludge, powder coat and/or latex paint is provided. The process can include providing paint sludge, powder coat and/or latex paint, and providing a second material, the paint sludge, powder coat and/or latex paint being a product of excess, waste and/or unsuitable material resulting from painting and/or powder coating an object and/or manufacture of the paint sludge, powder coat and/or latex paint itself The paint sludge, powder coat and/or latex paint and the second material can be mixed to produce a paint sludge, powder coat and/or latex paint-second material mixture (hereafter referred to as ‘material mixture’) and the material mixture can be processed in order to produce a precursor polymer in the form of particles, granules, flakes, pellets and the like. In the alternative, the material mixture can be processed to directly produce a solid component. The precursor polymer and/or solid component is produced by taking the paint sludge, powder coat and/or latex paint-second material mixture and processing with an extrusion press, e.g. an extrusion molding apparatus. In some instances, the process excludes processing with a densifier and/or granulator. It is appreciated that a third material, a fourth material and additional materials can also be mixed with the paint sludge, powder coat and/or latex paint.

The paint sludge, powder coat and/or latex paint can be collected from excess automotive painting and/or powder coating, and/or commercial and/or residential latex paint cans, however this is not required. The second material can be a virgin material such as a virgin polymer. In addition, the second material can contain recycled material such as a recycled polymer, recycled polymer filter media and the like.

In some instances, the paint sludge, powder coat and/or latex paint-second material mixture has a paint sludge, powder coat and/or latex paint content of between 1 to 99 weight percent. In other instances, the paint sludge, powder coat and/or latex paint content is between 10 to 90 weight percent, 20 to 80 weight percent, 30 to 70 weight percent or 40 to 60 weight percent. The solid component can have a density of greater than 80 percent of theoretical density and in some instances a density greater than 85 percent. In addition, the solid component can be in the form of a pallet, milk crate, dunnage and the like.

### BRIEF DESCRIPTION OF THE DRAWINGS

FIG. 1 is a schematic diagram of a process for producing a solid component from recycled paint sludge, powder coat and/or latex paint according to an embodiment of the present invention; and

FIG. 2 is a schematic diagram of a process for producing a solid component from recycled paint sludge, powder coat and/or latex paint according to another embodiment of the present invention.

### DETAILED DESCRIPTION OF THE INVENTION

The present invention includes a process for recycling paint sludge, powder coat and/or latex paint. As such, the process has utility for reducing waste sent to and placed in landfills.

The process includes taking paint sludge, powder coat and/or latex paint and mixing it with a second material, taking the paint sludge, powder coat and/or latex paint-second material mixture and producing a solid component by extrusion. In this manner, a granulating and/or densifying step is eliminated. It is further appreciated that the term “solid component” as used herein is defined as a component that has one or more physical dimensions that do not change when the component is placed unconstrained on a flat surface.

The second material can be a polymer, a natural fiber, paper and the like. The polymer, natural fiber and/or paper can be virgin material or recycled material. If the material is recycled, it can include recycled material from filter media, motor vehicle components, carpet, tires, furniture, building products, plastic bags, household items, and the like.

The paint sludge, powder coat and/or latex paint can be obtained from excess or waste paint, powder coat and/or latex paint used in a painting and/or powder coating process used in most any industrial and/or residential setting, for example and for illustrative purposes only, excess paint sludge, powder coat and/or latex paint resulting from the painting and/or powder coating of motor vehicles parts within a motor vehicle assembly facility, painting of residential and/or commercial structures and the like. In addition, the powder coat can be obtained from powder coat particles known as “fines” that are obtained from the process of manufacturing the powder coat itself and are undesirable for use in the powder coating process. It is appreciable that both types of powder coat particles, i.e. waste powder coat particles and the fines can be considered and referred to as waste powder coat and/or waste powder coat particles.

The paint sludge, powder coat and/or latex paint can be made from and/or include any paint sludge, powder coat and/or latex paint material known to those skilled in the art, illustratively including polyester, polyurethane, polyester-epoxy (known as hybrid), straight epoxy (fusion bonded epoxy) and acrylics. In addition, the paint sludge, powder coat and/or latex paint can be made from materials not currently known to make powder coat particles but will be used in the future.

A third material, a fourth material, etc. can also be mixed with the powder coat and be used to modify the chemical, mechanical and/or physical properties of the solid component that is produced with the recycled powder coat. For example and for illustrative purposes only particles, fibers, flakes and the like made from glass, carbon, SiC, SiN, metal, steel, etc. can be mixed with the powder coat to make a solid component.

The ratio of paint sludge, powder coat and/or latex paint to second material can be adjusted depending upon the solid component to be made therefrom, with weight percentages ranging from 1 to 99 weight percent paint sludge, powder coat and/or latex paint and 99 to 1 weight percent second material. In some instances, the paint sludge, powder coat and/or latex paint-second material mixture and/or the solid component can have a paint sludge, powder coat and/or latex paint content of between 10 to 90 weight percent. In other instances, the paint sludge, powder coat and/or latex paint content can be between 20 to 80 weight percent, 30 to 70 weight percent or 40 to 60 weight percent. It is appreciated that the remainder of the paint sludge, powder coat and/or latex paint -second material mixture and/or the component is made from the second material and/or any additional fillers that may be included to decrease cost, improve mechanical properties, improve chemical properties and the like. The solid component can have a density of greater than 80 percent of theoretical density (e.g. g/m³) for the solid component, and in some instances a density greater than 85 percent of theoretical density. It is appreciated that one skilled in the art will understand that the density percentage is a comparison to a theoretical density, e.g. 80 percent of theoretical density.

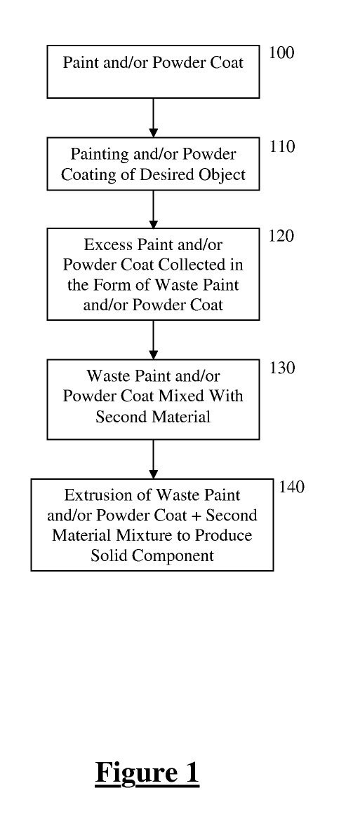

Turning now to FIG. 1, an embodiment of a process to recycle paint sludge, powder coat and/or latex paint is disclosed at reference numeral 10 with paint and/or powder coat supplied at step 100. For the purposes of FIG. 1, the term “paint” includes oil based paint and latex based paint. The paint and/or powder coat is used to paint and/or coat desired objects at step 110 and excess paint sludge, powder coat and/or latex paint is collected at step 120. It is appreciated that the term “paint sludge” refers to waste oil-based paint. The paint sludge, powder coat and/or latex paint is mixed with a second material at step 130 and the paint sludge, powder coat and/or latex paint plus second material mixture can be processed in a variety of ways such that pellets, granules, chips, small rods and the like can be used in a plastic molding machine to form desired items. The paint sludge, powder coat and/or latex paint can also be mixed with a third material, a fourth material and the like in order to obtain desired chemical, physical and/or mechanical properties in a manufactured solid component. In some instances, the paint sludge, powder coat and/or latex paint and second material mixture can be extruded as illustrated at step 140 in order to produce a solid component in the form of pellets, granules, chips, small rods, household items, automotive components, industrial components and the like.

It is appreciated that the paint sludge, powder coat and/or latex paint and/or paint sludge, powder coat and/or latex paint mixed with the second material can be optionally dried using any drying process and/or drying machinery known to those skilled in the art. The drying can result in the removal of excess water, volatile liquids and vapors, undesirable smells and the like from the paint sludge, powder coat and/or latex paint and/or paint sludge, powder coat and/or latex paint mixed with the second material and can include one or more drying steps. In addition, the drying can be performed using a sludge dryer, an oven, a conveyor belt with a heat lamp and the like. It is appreciated that air scrubbers, fuming hoods and the like can also be used to properly process any gases, vapors, etc., that may evolve from the powder coat before, during and/or after drying. It is further appreciated that the drying of the paint sludge, powder coat and/or latex paint and/or the paint sludge, powder coat and/or latex paint mixed with the second material can result in paint sludge, powder coat and/or latex paint that is easier to handle, ship, process and the like.

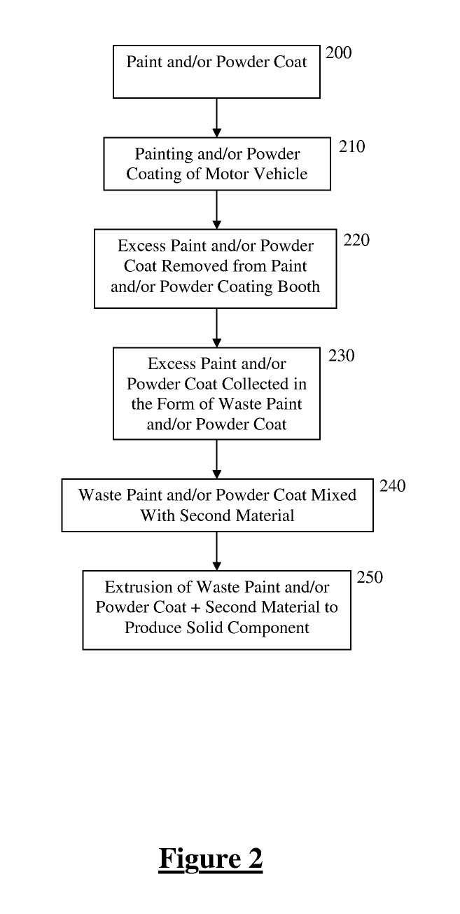

Turning now to FIG. 2 and reference numeral 20, paint and/or powder coat supplied at step 200 is used for painting and/or powder coating motor vehicles parts at step 210. Also, paint sludge and/or excess powder coat is removed from the coating environment (hereafter referred to as the paint and/or powder coating booth) within an automotive assembly facility at step 220. The excess paint sludge and/or powder coat and/or latex paint is collected in the form of waste paint sludge and/or powder coat at step 230.

Latex paint is supplied at step 202 and then used to paint a component at step 212. Also, excess latex paint is collected at step 222. Step 240 takes the waste paint, powder coat and/or latex paint and mixes it with a second material. An optional drying step of the paint, powder coat and/or latex paint can be included, as can a drying step of the waste paint, powder coat and/or latex paint-second material mixture. Similar to the embodiment shown in FIG. 1, the paint sludge, powder coat and/or latex paint-second material mixture is extruded at step 250 and solid components are produced.

It is appreciated that filter media obtained and/or recycled, in addition to virgin filter media, can be used, as well as recycled paper and material obtained from recycled motor vehicle components, carpet, tires, furniture, building products, plastic bags, household items and the like. It is also appreciated that various modifications are readily made to the embodiments of the present invention described herein without departing from the spirit and scope thereof. Accordingly, it is to be understood that the invention is not to be limited by the specific illustrated embodiment or embodiments, but by the scope of the appended claims.

We claim:

1. A process for making a solid component out of recycled paint sludge, powder coat and/or latex paint, the process comprising:
Providing paint sludge, powder coat and/or latex paint;
providing a second material;
mixing the paint sludge, powder coat and/or latex paint with the second material to produce a paint sludge, powder coat and/or latex paint-second material mixture;
extruding the paint sludge, powder coat and/or latex paint-second material mixture and producing a solid component.

2. The process of claim 1, wherein the powder coat is made from a polymer selected from a group consisting of a polyester, a polyurethane, a polyester-epoxy, a straight epoxy and an acrylic.

3. The process of claim 1, wherein the paint sludge, powder coat and/or latex paint-second material mixture has a paint sludge, powder coat and/or latex paint content of between 1 to 99 weight percent.

4. The process of claim 3, wherein the paint sludge, powder coat and/or latex paint content is between 20 to 80 weight percent.

5. The process of claim 4, wherein the paint sludge, powder coat and/or latex paint content is between 30 to 70 weight percent.

6. The process of claim 1, wherein the solid component has a density of greater than 80 percent of theoretical density.

7. The process of claim 6, wherein the solid component has a density of greater than 85 percent of theoretical density.

8. The process of claim 1, wherein the paint sludge, powder coat and/or latex paint is obtained from painting and/or powder coating at least part of a motor vehicle component.
